(19) United States
(12) Patent Application Publication
(10) Pub. No.: US 2008/0152442 A1
(43) Pub. Date: Jun. 26, 2008

(54) Drill Guide

(76) Inventor: Ralph Kent Barrett, Hendersonville, TN (US)

Correspondence Address: JAMES ADDISON BARRY, JR., 105 GLENWAY POINT, LEBANON, TN, 37087, US

(21) Appl. No.: 11/614,541

(22) Filed: Dec. 21, 2006

(51) Int. Cl. B23B 45/14; B23B 49/00; B25H 1/00; B23B 47/28; B23B 49/02; B23Q 3/18; B23B 35/00

(52) U.S. Cl. 408/1 R; 408/115 R

(57) ABSTRACT

A drill guide 10 comprising a V-block 20 including a first extension arm 22, a second extension arm 26, an edge 30 where the first extension arm 22 and the second extension arm 26 are joined 30 and form a V-shape 40, and an aperture 50 disposed in the edge 30 of the V-shape 40. A centerline 60 of the aperture 50 bisects a V angle 64 formed by the interior surfaces 23, 27 of the first and second extension arms 22, 26. This design allows the drill guide 10 to be placed over circular shaped material 90; a drill bit 92 to be received by the aperture 50; and the drill bit 92 to drill a hole may be drilled through the center of the circular shaped material 90.

### FIELD OF INVENTION

The present invention relates to a drill guide and, more specifically, to a hand held drill guide which can be used with a portable hand drill for accurate positioning of drill bits and control of the direction and course of the drill bits for drilling of cylindrical shaped workpieces.

### BACKGROUND OF INVENTION

Problems with drilling cylindrical-shaped workpieces reside in locating the drill precisely at the spot to be drilled and then maintaining the direction and course of the drill during the drilling operation. In drilling cylindrical-shaped workpieces, the drill tends to wander on the cylindrical surface when drilling is started; and, once drilling has begun, it is difficult to keep the drill bit in proper alignment which results in sticking of the drill bit in the drill hole and possible breaking of the drill bit. Several patents involve some sort of fixture for holding the workpiece in place as well as some form of drill guide. The problem with the prior art, however, is that the drill fixtures typically are made up of relatively complicated mechanisms for holding the workpiece and centering the drill as well as lacking both an efficient design and versatility. Typically, these prior fixtures lack compactness and economies of manufacture. Another problem with the prior art is that the workpiece may need to be clamped or bolted to the drill guide for an accurate alignment of the drill hole.

### BRIEF DESCRIPTION OF THE DRAWINGS

The features, aspects, and advantages of the invention will become better understood with regard to the following description, appended claims, and accompanying drawings where:

FIG. 1 is a perspective view of one embodiment of the guide according to the present invention;

FIG. 2 is a side view of another embodiment of the guide according to the present invention;

FIG. 3 is a top view of an embodiment of the guide according to the present invention;

FIG. 4 is a cross section through the guide shown in FIG. 3 along the line 4-4; and

FIG. 5 is a side view of yet another embodiment of the guide according to the present invention.

### DETAILED DESCRIPTION OF THE INVENTION

The present invention relates to the field of drill guides, and provides a means for using a hand held drill guide in combination with a portable hand drill for accurate positioning of drill bits and control of the direction and course of the drill bits for drilling circular and cylindrical shaped workpieces/materials. In addition, this invention provides an apparatus and a method to drill a hole through the center of the circular shaped material. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

Overview of the Invention:

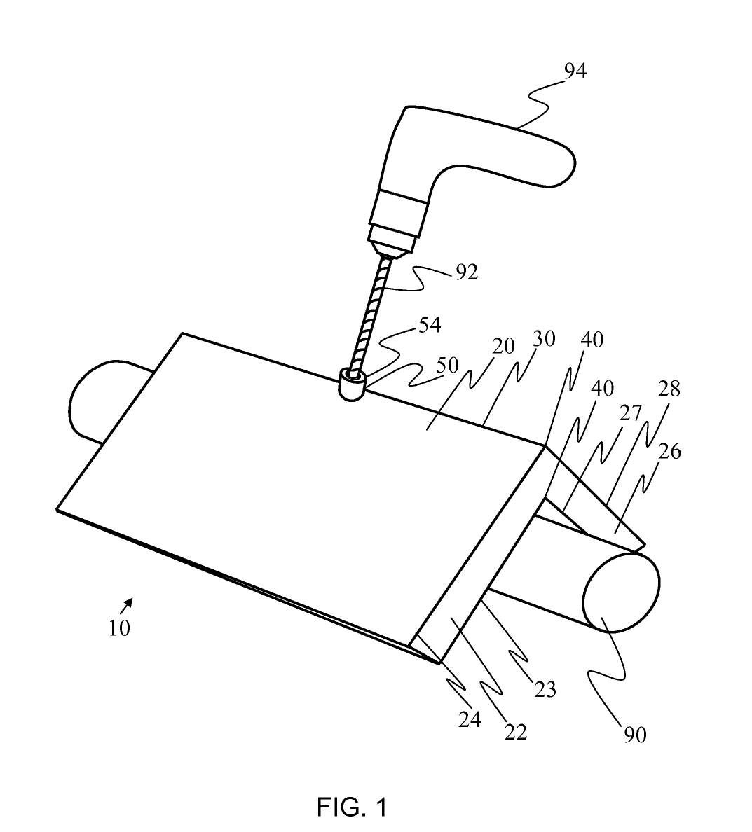

As depicted in FIGS. 1, 2, 3, and 4, one embodiment of the drill guide 10 comprises a V-block 20 where the V-block 20 includes a first extension arm 22, and a second extension arm 26, an edge 30 where the first extension arm 22 and the second extension arm 26 are joined 30 or meet and form a V-shape 40, and an aperture 50 or hole disposed in the edge 30 of the V-shape 40. The aperture 50 is constructed such that the centerline 60 of the aperture 50 bisects a V-shaped angle 64 formed by the interior surface 23 of the first extension arm 22 and the interior surface 27 of the second extension arm 26. This design allows the drill guide 10 or V-block 20 to be placed over circular shaped material 90; a drill bit 92 to be received by the aperture 50; and the drill bit 92 to pass through the center of the circular shaped or circular material 90 thus a hole may be drilled through a center of the circular shaped material 90.

Design Specifications:

The drill guide 10 comprises a V-block 20 and an aperture 50. The V-block 20 includes a first extension arm 22, a second extension arm 26, and an edge 30 formed where the first and second extension arms 22, 26 join. The edge 30, the first extension arm 22, and the second extension arm 22 form a V-shape 40. The V angle 64 is formed by the interior or inside surfaces 23, 27 of the extension arms 22, 26 that form the V-shape 40 or V-shaped groove. The V angle 64 may be an approximate 90 degree angle defined as the range between 60 degrees and 120 degrees and including 60 and 120 degree angles. An outside angle may also be formed by exterior or outside surfaces 24, 28 of the extension arms 22, 26 that may also form a V-shape 40. The first and second extension arms 22, 26 and the edge 30 may be constructed from any suitable materials including but not limited to steel, aluminum, stainless steel, composite, or carbon fiber. The first and second extension arms 22, 26 and the edge 30 construction may include but is not limited to one piece molded or formed construction; plates connected together to form a V-shape construction; angle iron construction; or other methods of construction. The size of the extension arm 22, 26 may vary depending upon the size of the circular shaped material 90 to be drilled and the size of the hole to be drilled in the material 90. Suggested extension arm sizes may include but are not limited to: thicknesses ranging from approximately 1/16 inch to 2 inches; widths varying from 1 inch to 1 foot; and lengths varying from 1/16 inch to 2 feet. One example of an embodiment of first and second extension arms 22, 26 and the edge 30 may include steel molded into the V-shape with each extension arm ⅜ inch thick, 3½ inches wide, and 2 inches length. Many other dimensions may be used.

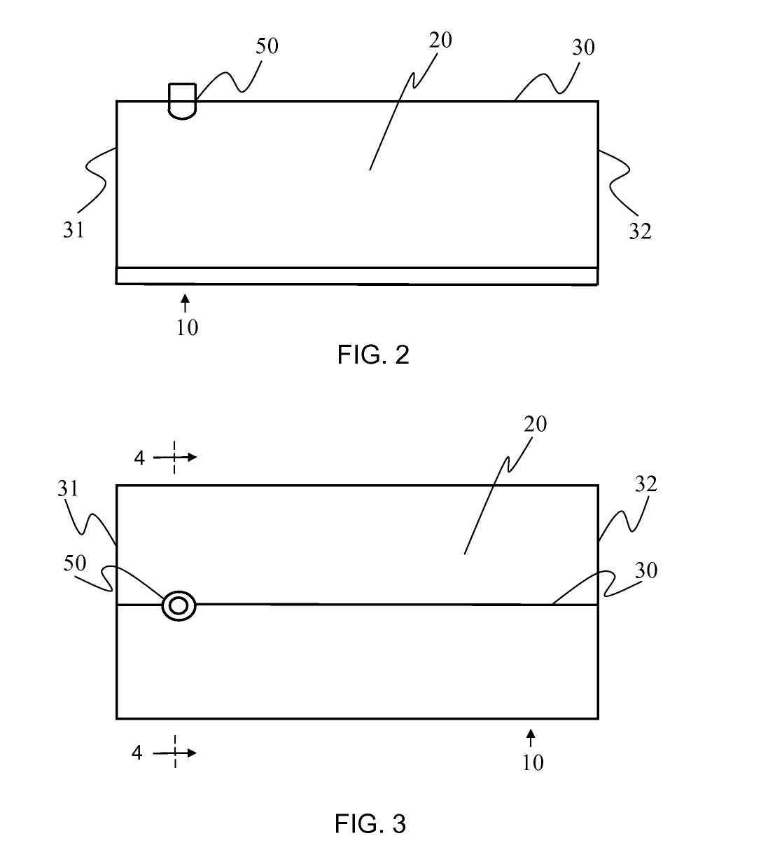

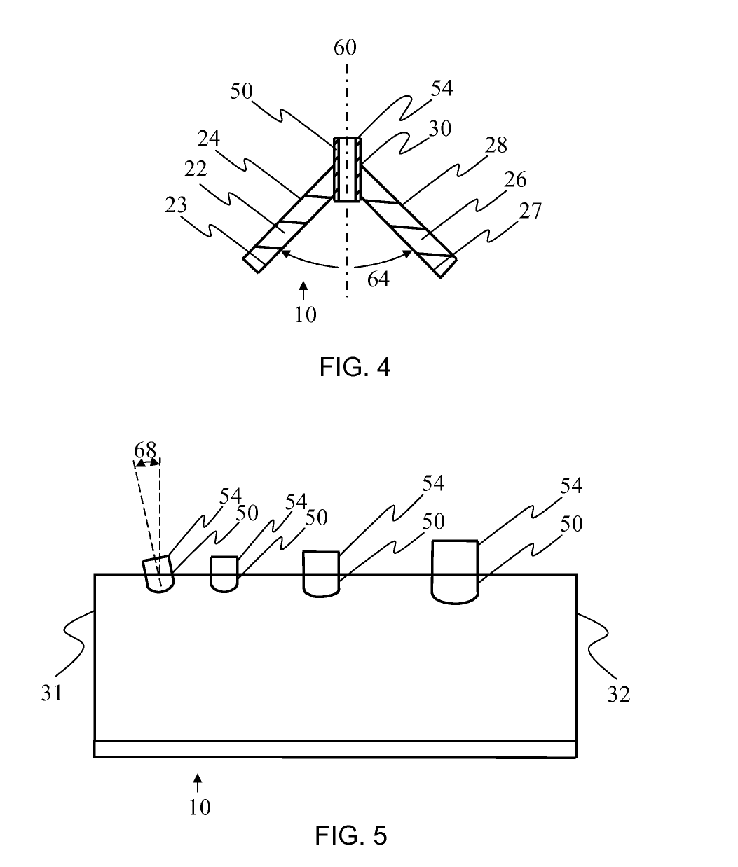

The V-block 20 further comprises a means for guiding a drill bit 92 through the V-block 20 such that the drill bit 92 is guided through the V-block 20 at a centering angle that bisects the inside surfaces 23, 27 of the first and second extension arms 22, 26. The means for guiding the drill bit 92 causes the drill bit 92 to bisect the V angle 64 formed by the interior surfaces 23, 27 of the first and second extension arms 22, 26. This V angle 64 along with the extension arms 22, 26 insures that the drill bit 92 will pass through the center of the cross section of the circular material 90 and that the circular shaped material 90 may have the entry and exit points of the drill bit 92 180 degrees apart from the entry and exit. The means for guiding the drill bit 92 may be an aperture 50 disposed in the edge 30 of the V-shape 40 or V-block 20 constructed such that the centerline 60 of the aperture 50 bisects the V angle 64 formed by the interior or inside surfaces 23, 27 of the first extension arm 22 and the second extension arm 26. When the V-block 20 or drill guide 10 is disposed on a circular shaped material 90 and when a drill bit 92 is received in the aperture 50 a hole may be drilled through the center of the circular shaped material 90. In one embodiment, the aperture 50 may be a smooth circular shaped aperture. The aperture 50 may have a diameter to receive the drill bit 92 or the aperture 50 may have a diameter to receive a bushing 54 depending upon the desired embodiment. The aperture 50 may be disposed along the edge 30 of the V-block 20. As depicted in FIGS. 2, 3, and 5, the aperture 50 may be disposed between the sides 31, 32 of the V-block 20 along the edge 30 whereby the drill guide 10 may be used to drill a hole in the circular shaped material closer to an obstacle. For example, the aperture 50 may be disposed on the edge 30 of the V-block 20 such that the diameter of the aperture 50 may be as close as 1/16 inch from the side of the V-block 20 for drilling holes close to obstacles. In one embodiment, the centerline 60 of the aperture 50 or bushing 54 may be perpendicular to the longitudinal axis of the V-block 20 edge 30. In another embodiment, the centerline of the aperture 50 or the bushing 54 may be offset at an offset angle 68 in relation to the perpendicular of the longitudinal plane. This offset angle 68 is shown in FIG. 5. The offset angle 68 in combination with the V angle 64 may allow a hole to be drilled through the center of a circular material and drilled at a desired offset angle 68 or slant from the perpendicular of the longitudinal axis up to a fifty degree offset from the perpendicular. FIG. 5 shows an embodiment of the drill guide 10 with multiple apertures 50 of differing diameters that may be used with different embodiments and different size drill bits. Bushings 54 may be inserted into the aperture 50 to receive drill bits into the bushings 54. Referring to FIGS. 1 and 4, the bushing 54 may be disposed in the aperture 50 of the V-block 20 such that a centerline 60 of the bushing 54 bisects the V angle 64 formed by the interior surfaces 23, 27 of the first extension arm 22 and the second extension arm 26. As shown in FIGS. 1, 2, 4, and 5, the bushing 54 may extend above and/or below the V-block 20 edge 30. The alignment of the aperture 50 and the bushing 54 allow for the precise drilling of a hole through the center of the circular shaped material 90 where the entry and exit holes may be 180 degrees apart. More than one bushing 54 may be disposed in the edge 30 of the V-block 20. Multiple sized bushings may be included along the edge 30 for receiving different size drill bits. In another embodiment, for one size outside diameter bushing 54, different size inside diameter bushing guides may be used for receiving different size drill bits. These exchangeable bushings allow for a V-block 20 with a certain diameter aperture 50 to be useful for drilling multiple diameter holes by exchanging, or slipping the bushings 54 in and out of the V-block 20. The bushing 54 may be press fit into the aperture 50 by machine, glued in place, welded in place, or allowed to be received into or removed from the aperture 50 by hand for ease of changing bushings 54 within the drill guide 10. The bushing 54 may be constructed from any suitable materials including but not limited to steel, aluminum, stainless steel, composite, or carbon fiber. The bushing 54 and the V-block 20 may be constructed from similar or dissimilar materials. Many combinations of diameters are possible. An example of one embodiment may include but is not limited to an aperture diameter of 17/32 inch that might be useful with bushings of a ½ inch outside diameter and multiple inside diameters varying between ⅜ inch and ⅛ inch. Circular shaped material 90 may be defined as: pipe, tubing, rod, sphere, or ball material.

As depicted in FIG. 1, another embodiment of the drill guide 10 includes in combination, the drill guide 10, the hand drill 94; and the drill bit 92; such that when the hand drill 94 receives the drill bit 92, the V-shape 40 receives the circular shaped material 90, and the aperture 50 receives the drill bit 92, the hole may be drilled through the center of the circular shaped material 90.

As illustrated in FIGS. 1, and 4, another embodiment of the drill guide 10 consists essentially of a V-block 20 including a first extension arm 22, a second extension arm 26, an edge 30 where the first extension arm 22 and the second extension arm 26 are joined and wherein the edge 30, the first extension arm inside surface 23, and the second extension arm inside surface 27 form a V-shape 40, and a means for guiding a drill bit through the V-block 20 disposed in the edge 30 such that a drill bit 92 is guided through the V-block 20 to cause the drill bit 92 to bisect a V angle 64 formed by interior surfaces 23, 27 of the first and second extension arms 22, 26; whereby when the V-block 20 is disposed on a circular shaped material 90 and when a drill bit 92 is received in the aperture 50 a hole may be drilled through a center of the circular shaped material 90. With this embodiment, there is no need for the drill guide 10 to be clamped or bolted to the circular shaped workpiece/material 90 nor is there a need for a drill press.

Manner of use:

As depicted in FIG. 1, the drill guide 10 may be used for drilling holes through the center of a circular shaped material 90. The drill guide 10 may be used by grasping the drill guide 10 and aligning the aperture 50 of the drill guide 10 with the desired location for the entry hole to be drilled by positioning or placing the drill guide 10 over the circular shaped material 90 to be bored or drilled. A hand drill 94 may be used for drilling the hole through the circular shaped material 90 by inserting a drill bit 92 through the aperture 50 of the drill guide 10. After completing the drilling of the hole, the hand drill 94 and the drill bit 92 are removed and the drill guide 10 is removed from over the circular shaped material 90.

This is a method of drilling a hole through the center of a circular shaped material 90 with a drill guide 10 where the center hole drill guide method comprises the steps of: grasping the drill guide 10, aligning the aperture 50 of the drill guide 10 with the location on the circular shaped material to drill the hole by placing the drill guide 10 over the circular shaped material 90 to be drilled, drilling with a hand drill the hole through the circular shaped material 90 by inserting a drill bit 92 through the aperture 50 of the drill guide 10, and removing the hand drill 94 with bit from the hole that was drilled, and the drill guide 10 from the circular shaped material 90 whereby the drilling creates the hole through a center of the circular shaped material 90. Another embodiment of this method comprises grasping a drill guide that is a V-block 20 where the V-block 20 includes a first extension arm 22, and a second extension arm 26, an edge 30 where the first extension arm 22 and the second extension arm 26 are joined 30 wherein the edge 30, the first extension arm 22, and the second extension arm 26 form a V-shape 40, and an aperture 50 or hole disposed in the edge 30 of the V-shape 40. The aperture 50 is constructed such that the centerline 60 of the aperture 50 bisects an V angle 64 formed by the interior surface 23 of the first extension arm 22 and the interior surface 27 of the second extension arm 26.

Uniqueness:

The drill guide 10 is a compact, lightweight, hand held, portable, inexpensive, simple, accurate apparatus that may be used with a hand drill 94 for drilling through circular shaped materials 90, even in hard to get to places. The V-block 20 is disposed over the circular shaped material 90 and the drill bit 92 passed through the V-block 20 edge 30 verses apparatus requiring a drill press aligned with the V shaped block holding the circular material that requires the drill to go through the circular material and then into an area on the V shaped block. This allows the V-block 20 precise alignment without bulky, large, equipment for alignment; this also eliminates the need for clamping as well as having the circular material held on both sides by a V shaped block as well as another plate with a bushing or drill guide. Further, there is no need for a base plate to hold the V shaped block extension arms, nor bolts or chains for clamping the V shaped block with the circular material. The extension arms 22, 26 extend outward from the edge 30 joining the extension arms wherein a V-shape is formed by the extension arms 22, 26. The drill guide 10 may be hand held in place over the circular shaped material with the drill bit 92 passing through the guide at the precise angle to position the entry and exit holes on opposite sides of the circular shaped material.

What is claimed is:

1. A drill guide comprising:
a V-block including:
a first extension arm,
a second extension arm,
an edge where the first extension arm and the second extension arm are joined wherein the edge, the first extension arm, and the second extension arm form a V-shape, and
an aperture disposed in the edge of the V-shape wherein the centerline of the aperture bisects a V angle formed by an interior surface of the first extension arm and an interior surface of the second extension arm;
whereby when the V-block is disposed on a circular shaped material and when a drill bit is received in the aperture a hole may be drilled through a center of the circular shaped material.

2. The drill guide according to claim 1 wherein the aperture is a smooth circular shaped aperture.

3. The drill guide according to claim 1 wherein the V-block first extension arm and the V-block second extension arm interior surfaces form the V-shape with the interior surfaces of the V-block and the V-block first extension arm and the V-block second extension arm exterior surfaces form the V-shape with the exterior surfaces of the V-block.

4. The drill guide according to claim 1 wherein the V angle is approximately 90 degrees.

5. The drill guide according to claim 1 wherein the V-block comprises a material selected from a group consisting of: steel, aluminum, hardened steel, stainless steel, composite, or carbon fiber.

6. The drill guide according to claim 1 further comprising:
a bushing disposed in the aperture of the V-block wherein a centerline of the bushing bisects the V angle formed by the interior surfaces of the first extension arm and the second extension arm.

7. The drill guide according to claim 6 further comprising multiple sized bushings along the edge for receiving different size drill bits.

8. The drill guide according to claim 6 further comprising multiple exchangeable bushings for disposition in the aperture along the edge of the V-block such that the exchangeable bushings may be received and removed from the aperture by hand for receiving different size drill bits.

9. The drill guide according to claim 6 wherein the aperture is disposed between a side of the V-block edge and a middle of the V-block edge, whereby the drill guide may be used to drill a hole in the circular shaped material closer to an obstacle.

10. The drill guide according to claim 6 wherein the centerline of the aperture is offset an offset angle in relation to the perpendicular of the longitudinal plane.

11. The drill guide according to claim 6 wherein the bushing extends beyond the V-block edge; and the bushing comprises a material selected from a group consisting of: steel, aluminum, hardened steel, stainless steel, composite, or carbon fiber.

12. The drill guide according to claim 6 wherein:
the bushing comprises a ⅝ inch outside diameter, a ½ inch internal diameter, and a 1 inch length;
a width of the extension arm comprises a 3½ inch width;
a thickness of the extension arm comprises a ⅜ inch thickness; and
a distance of the extension arm from the edge of the V-block to the end of the extension arm comprises a 2 inch distance.

13. The drill guide according to claim 1 comprising in combination:
the drill guide; a hand drill; and a drill bit;
whereby when the hand drill receives the drill bit, the V-shape receives the circular shaped material, and the aperture receives the drill bit, the hole may be drilled through the center of the circular shaped material.

14. A drill guide for a circular material, the drill guide comprising:
a hand held V-block including:
a first extension arm forming a part of the V-block,
a second extension arm forming a part of the V-block,
an edge forming a part of the V-block further forming a V-shape where the first extension arm of the V-block and the second extension arm of the V-block meet at the edge, and
a means for guiding a drill bit through the V-block disposed in the edge such that a drill bit is guided through the V-block to cause the drill bit to bisect an V angle formed by interior surfaces of the first and second extension arms;
whereby the entry and exit points of the drill are 180 degree apart and the drill bit passes through the center of the cross section of the circular material.

15. A method of drilling a hole comprising the steps of:
grasping a drill guide,
aligning an aperture of the drill guide with a location on a circular shaped material to drill the hole by placing the drill guide over the circular shaped material to be drilled,
drilling with a hand drill the hole through the circular shaped material by inserting a drill bit through the aperture of the drill guide, and
removing the hand drill with the drill bit from the hole that was drilled and the drill guide from over the circular shaped material,
whereby the drilling creates the hole through a center of the circular shaped material.

16. A method of claim 15, wherein the drill guide includes a first extension arm, a second extension arm, an edge where the first extension arm and the second extension arm are joined wherein the edge, the first extension arm, and the second extension arm form a V-shape, and an aperture disposed in the edge of the V-shape wherein the centerline of the aperture bisects a V angle formed by an interior surface of the first extension arm and an interior surface of the second extension arm.
